(19) United States
(12) Patent Application Publication
(10) Pub. No.: US 2025/0343699 A1
(43) Pub. Date: Nov. 6, 2025

(54) SYSTEM AND METHOD FOR A MONOTONIC COUNTER

(71) Applicant: Connaught Electronics Ltd., Tuam (IE)

(72) Inventor: Seok Bae YUN, Troy, MI (US)

(21) Appl. No.: 18/655,157

(22) Filed: May 3, 2024

(51) Int. Cl. H04L 9/32; G06F 7/58; H04L 9/06; H04L 9/40

(52) U.S. Cl. CPC H04L 9/3247; G06F 7/588; H04L 9/0631; H04L 63/0838

(57) ABSTRACT

A system configured to encrypt vehicle communication includes a hardware extension that includes a true-random number generator (TRNG) configured to output a true-random number, a random-access memory configured to store the true-random number as a one-time password and a counter value received from a counter, and control logic configured to send the one-time password to an advanced encryption standard (AES) block cipher configured to encrypt the one-time password with the counter value to generate a signature, a controller in communication with the hardware extension, the controller configured to receive, the signature, store the signature at a memory, and increase the counter value at the counter to establish a second counter value.

### TECHNICAL FIELD

The present disclosure relates to security in a computing device, such as in an automotive vehicle.

### BACKGROUND

Hardware security module (HSM) is a security device which can provide a dedicated secure processor and secure memory. It can be used for implementing a monotonic counter to prevent the malicious attacks using replay attacks by recording the previous communication messages and replaying them in order to obtain the privilege to control the system. SHE (Secure Hardware Extension), specifically AUTOSAR-SHE compliant (Automotive Open System Architecture), is a cheaper and simpler device for cyber security compared to HSM, but cannot support a monotonic counter due to the lack of dedicated secure memory and secure processor. Thus, a monotonic counter may need to be implemented using software and limited hardware resources of AUTOSAR-SHE, so as to prevent modification and decrement of counter value, which the counter number can only be increased (never decreased) in the message to protect the system from replay attacks.

### SUMMARY

A first embodiment discloses a system configured to encrypt vehicle communication includes a hardware extension that includes a true-random number generator (TRNG) configured to output a true-random number, a random-access memory configured to store the true-random number as a one-time password and a counter value received from a counter, and control logic configured to send the one-time password to an advanced encryption standard (AES) block cipher configured to encrypt the one-time password with the counter value to generate a signature, a controller in communication with the hardware extension, the controller configured to receive, the signature, store the signature at a memory, and increase the counter value at the counter to establish a second counter value.

A second embodiment discloses a method of verification for cryptographic vehicle communication, comprising verifying a one-time password generated from a TRNG of a hardware extension, wherein the one-time password is stored at a random access memory (RAM) of the hardware extension, receiving, from a controller, an encrypted signature at the hardware extension, decrypting the encrypted signature at an AES block cipher to obtain a decrypted value, obtaining a counter value from the controller, wherein the counter value is derived from a monotonic counter, and comparing the counter value to the decrypted value.

A third embodiment discloses a method of verifying a communication in a vehicle comprising outputting a true-random number utilizing a TRNG of a hardware extension, storing the true-random number in RAM, wherein the RAM is configured to store the true-random number as a one-time password, receiving, from a monotonic counter, a counter value at the hardware extension, sending the one-time password to an AES block cipher configured to encrypt the one-time password utilizing the counter value to generate an encrypted signature, storing the encrypted signature, verifying the one-time password generated from the TRNG, receiving, from a controller, the encrypted signature at the hardware extension, decrypting the encrypted signature at the AES block cipher to obtain a decrypted value, obtaining the counter value from the controller, wherein the counter value is derived from the monotonic counter, and comparing the counter value to the decrypted value.

### BRIEF DESCRIPTION OF THE DRAWINGS

FIG. 1 illustrates an embodiment of a monotonic counter that includes an AES-ECB and TRNG with a counter value for encryption.

FIG. 2 illustrates an example of a monotonic counter that includes an AES-ECB and TRNG with a counter value for decryption.

FIG. 3 illustrates an example of a monotonic counter that includes an encryption process with a base time component.

FIG. 4 illustrates an example of a monotonic counter that includes a decryption process with a base time component.

FIG. 5 illustrates a system overview according to an embodiment including encryption of a monotonic counter with AES-ECB (electronic codebook mode).

FIG. 6 illustrates a system overview according to an embodiment including a verification and decryption process of a monotonic counter with AES-ECB (electronic codebook mode).

FIG. 7 illustrates a system overview according to an embodiment including an encryption process of a monotonic counter with AES-ECB iteration encryption utilizing multiple, dedicated AES crypto engines.

FIG. 8 illustrates a system overview according to an embodiment including a verification and decryption process of a monotonic counter with AES-ECB iteration encryption utilizing multiple, dedicated AES crypto engines.

FIG. 9 includes a system overview according to an embodiment including encryption of a monotonic counter with AES-ECB iteration encryption without a true random generator and multiple AES crypto engines.

FIG. 10 includes a system overview according to an embodiment including a decryption of a monotonic counter with AES-ECB iteration encryption without a true random generator and multiple AES crypto engines.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

A system and method is proposed that may utilize Advanced Encryption Standard-Electronic Code Book (AES-ECB) to encrypt the counter value using a one time password (OTP) to help prevent replay attacks. The OTP can be generated by the use of a true random number generator (TRNG) and a random access memory-key (RAM-Key) of AUTOSAR-SHE for one or more messages, such as every message.

Such a system may provide for universal tamper and replay attack resistance to the software monotonic counter, rather than expensive and complicated hardware security model, for any microcontroller utilized that is AUTOSAR compliant SHE device. The AUTOSAR-SHE may be an industrial standard model and a variety of MCUs use it. AUTOSAR-SHE compliant devices may be cheaper than HSM, so cost reduction may be an advantage.

A monotonic counter may be utilized to aid a system to prevent attacks that attempt to infiltrate the system. One of the well-known attacks to communication systems is a so-called “replay attack.” The attacker may just record the previous communication messages and replay them. Adding a counter number to each message, which can only be increased but never decreased, can protect the system from the replay attack.

The software counter cannot guarantee monotonic increase because the memory which the software runs on can be easily changed by attackers or incidents. The HSM provides physical isolation from the main processor and memory. The attacker cannot change the counter number because the counter inside HSM can only be accessible to the authorized users or processes.

A controller may execute a signing operation that utilizes a signing key to produce a signature over the OTP. The AES crypto engine may be utilized to create a signed OTP utilizing the encryption private key. A decryption key may be utilized that corresponds to the signing key and utilized to decrypt the signed OTP. The counter value may be utilized to compare with the original value. Each counter value may have its own unique signature and unique secret key protected by the SHE key memory. Since the OTP keeps changing for each new counter value, the result may be irreversible and time-variant.

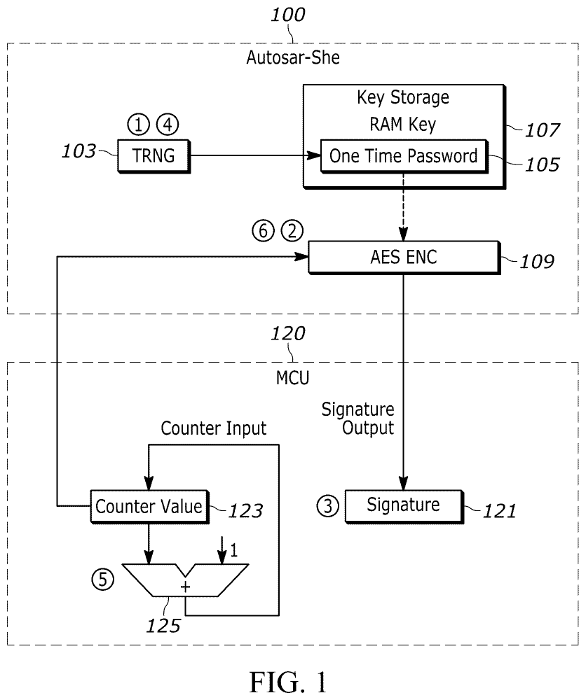

FIG. 1 illustrates an embodiment of a monotonic counter that includes an AES-ECB and TRNG with a counter value for encryption. The system may include an AUTOSAR-SHE module 100 in one embodiment. The Secure Hardware Extension (SHE) may be an on-chip extension or external add-on device to any given microcontroller or controller. The SHE may be utilized to move control over cryptographic keys from a software domain into the hardware domain, and therefore protect those keys from various types of attacks, including software attacks. The SHE may be utilized to protect cryptographic keys from software attacks and provide an authentic software environment, as well as let the security depend on the strength of the underlying algorithm and the confidentiality of the keys, allow for distributed key ownerships, and allow for the flexibility to be high while lowering costs. At a high level, the SHE may include three main components, (1) a storage area to keep the cryptographic keys and additional corresponding information, (2) a implementation of a block cipher (e.g., AES), and (3) a control logic connecting the parts to the CPU of the microcontroller.

The AUTOSAR-SHE module 100 may include a true random number generator (TRNG) 103. The TRNG 103 may be a device that generates a random number every time. The TRNG may generate the random number from a physical process that is capable of producing entropy. The TRNG may be different from a pseudo-random number generator (PRNG). A TRNG may be utilized to create random cryptographic keys and a nonce that are needed to encrypt and sign data. In the embodiment disclosed below, the system may utilize the TRNG 103 to generate a one-time password (OTP) 105. As such, the OTP may only be utilized once. The OTP 105 may be stored in a key storage 107 that may be a RAM (random access memory) KEY. The RAM may be rewritable to store additional one-time passwords.

The RAM memory of the key storage 107 may be any type of RAM memory. In one embodiment, the RAM memory may be DRAM (Dynamic RAM). DRAM may need to be refreshed thousands of times per second, as it stores each bit of data in a separate capacitor within an integrated circuit. Another embodiment may include SRAM (Static RAM). Unlike DRAM, SRAM may not need to be refreshed, which makes it faster but also more expensive. It may utilize flip-flops to store each bit of data, and it is often used in cache memory. In yet another embodiment, the key storage 107 may be SDRAM (Synchronous Dynamic RAM). SDRAM may be synchronized with the system bus speed, allowing for faster data transfer rates. Another example of RAM memory may include DDR SDRAM (Double Data Rate Synchronous Dynamic RAM). DDR SDRAM may transfer data on both the rising and falling edges of the clock signal, effectively doubling the data transfer rate compared to traditional SDRAM. Another example of the key storage may include DDR2, DDR3, DDR4, and DDR5. These may be different generations of DDR SDRAM, each providing improvements in speed, bandwidth, and power efficiency.

The AutoSAR-SHE module 100 may also include an AES component 109 that is utilized for encryption and decryption. AES (Advanced Encryption Standard) is a symmetric encryption algorithm, and its implementation can vary. In one embodiment, the AES component 109 may be dedicated cryptographic processors or modules. These can be one or more separate chip components designed to accelerate cryptographic operations, such as the AES encryption and decryption. The built-in hardware support for AES instructions can significantly enhance the performance of AES encryption and decryption compared to software-only implementations. Such instructions may be part of the CPU's instruction set and enable more efficient processing of AES operations, in one embodiment. In one alternative embodiment, the AES encryption and decryption processes may be performed by software running on a general-purpose CPU (Central Processing Unit). In such an embodiment, the AES may not be a separate chip component but is handled by the computer's main processor.

In a first step, the system may generate a one-time password (OTP) 105 utilizing the TRNG 103. In a second step, the system may send a counter value 123 obtained from counter 125 at the MCU 120, to the AES-ECB 109 of AutoSAR-SHE module 100. In a third step, the system may output an unique digital signature 121 that is based on AES algorithm and a symmetric key utilized by the AES crypto engine 109. The signature may be corresponding to a combination of the one-time password 105 and the counter value 123 that is obtained from the MCU 120. In other embodiments disclosed below, the signature 121 may be created by utilizing any one of the combinations of the OTP, counter value, base time, iteration number, or any other combination of data. The signature 121 may be utilized for secure communication or secure processing.

In updating a next counter value, the system may update the OTP 105 in the RAM key slot of the key storage 107 with a new TRNG value obtained from the TRNG 103 in a fourth step. In a fifth step, the counter value may be increased (e.g., by 1), and may never be decreased if a monotonic counter is utilized. But alternative embodiments may contemplate other types of counters. In a sixth step, the system may encrypt the counter value using the AES-Electronic Codebook Mode Encryption (AES-ECB). The system may repeat the fourth, fifth and sixth steps to obtain new counter values during additional communication and/or processing.

In one embodiment, the system may only need to utilize a single input (counter value) that is required. The system may be tamper resistant and replay attack resistant. The implementation may be easy to implement with SHE. However, a drawback may include lack of confidentiality of the counter value on the MCU side. In an alternative embodiment, the TRNG may not be utilized for decryption in one embodiment.

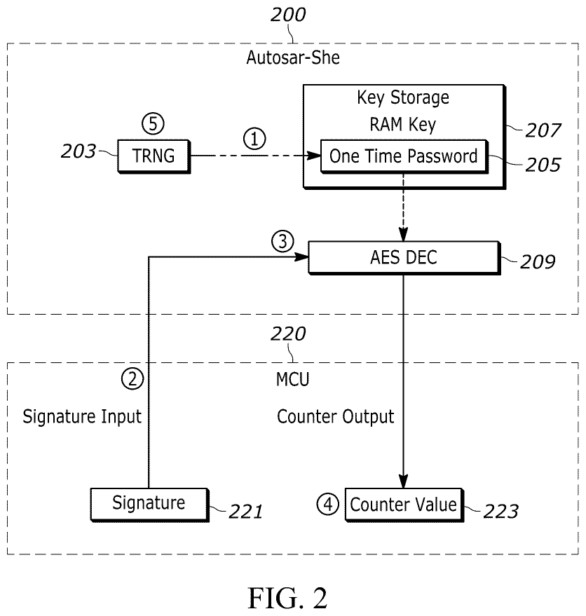

FIG. 2 illustrates an example of a monotonic counter that includes an AES-ECB and TRNG with a counter value for decryption and verification. The AutoSAR-SHE module 200 may be substituted by any type of SHE module. The TRNG 203 may output a true-random number to the key storage 207, which is shown at step 1. The key storage may include RAM memory with a RAM key slot dedicated to a one time password 205. This key in the RAM key slot must be the same as the key used for encryption. During the verification process, the system may ensure that the OTP is unchanged in the first step of the decryption process. The system may load the signature to the SHE module in a second step.

The microcontroller unit 220 may include a signature 221 and a counter value 223. The signature input may be sent from the signature 221 to the AES DEC 209 as shown in a second step. At a third step, the AES Decoder 209 may decode the signature, which may be utilized to obtain a number to compare with the counter value 223. At a fourth step, the system may obtain the counter value at the MCU after decoding and compare with the original value. Assuming that the number matches, it can be assumed that there is no breach within the security of the system. If the decoded counter output does not match, then the system can assume that there is a breach. A fifth step, the TRNG 203 may provide an additional true-random number to begin the process all over again for communication or processes.

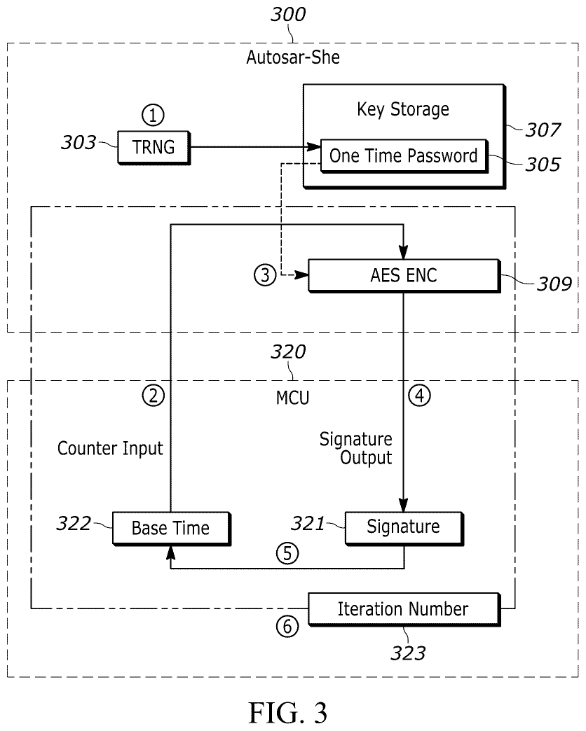

FIG. 3 illustrates an alternative design to maintain the confidentiality of counter value, which is free from the vulnerability of the counter value previously explained. The example of a monotonic counter that includes an encryption process with a base time component. The AutoSAR-SHE module 300 may include a true random number generator (TRNG) 303. In a first step, the TRNG 303 may output the true-random number to the key storage 307. The key storage 307 may include RAM memory for the key slot. In a second step, the counter input may be sent to the AES crypto engine 309 from a base time 322 component of the MCU 320. The base time 322 component may provide a time indicator (e.g. a time stamp) of when a message is communicated (e.g. sent or received). In a third step, a one-time password 305 may be sent to the AES crypto engine 309 for encoding. The signature output may be sent from the AES crypto engine 309 to the MCU and stored as signature 321 in a fourth step. Upon being received at the MCU 320, the signature may be replaced with the timestamp. The iteration number 323 is not explicitly shown but implies the counter number. This mechanism provides counter confidentiality by hiding the counter number completely. The counter number never exists in any memory.

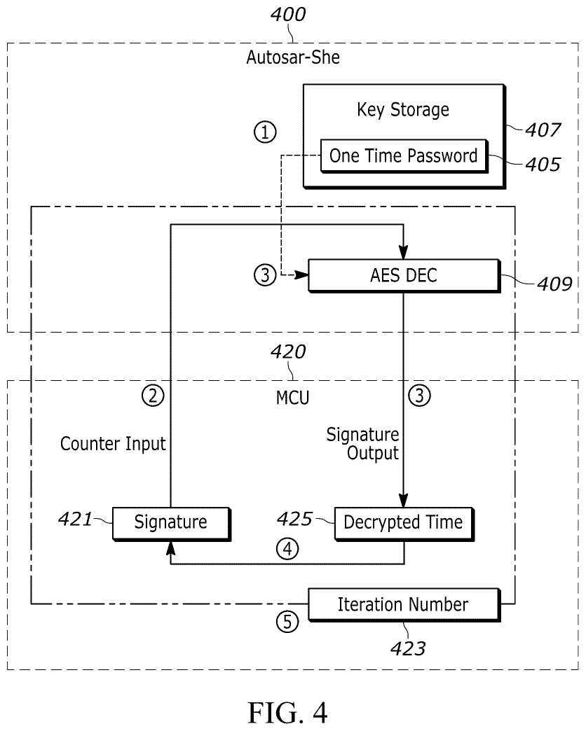

FIG. 4 illustrates an example of a monotonic counter that includes a decryption process with a base time component. The decryption may be done during a verification process. The AUTOSAR-SHE module 400 may include a key store memory 407 that includes a stored one-time password 405. A controller may confirm that the one-time password 405 is unchanged. At a first step, the one-time password 405 is stored in the key storage 407. At a second step, the system may load the signature 421 into the AES module 409. The AES module 409 may be utilized to decrypt the signature in a third step. The AES crypto engine 409 may output the decrypted signature to the MCU 420 for further verification.

The MCU 420 may obtain a counter value by increasing the number of iterations of the decryption process from the base time and store the number into iteration number 423. This process may be repeated until getting the same value of the base time. If the decrypted time 425 and base time are identical after a certain amount of iterations, the system may verify the message or data that is not being replayed. If the decrypted time 425 does not match with the base time until iteration number reaches the maximum number, the system may be alerted to knowing that there may be a data breach or security issue.

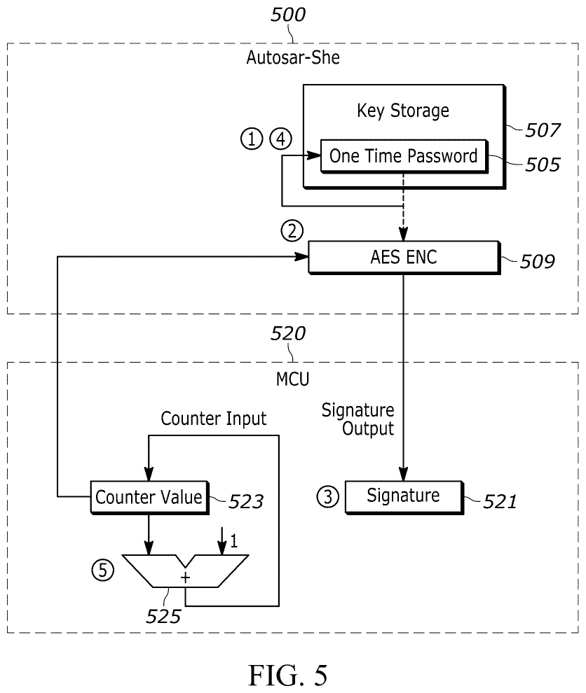

FIG. 5 includes a system overview according to an embodiment including encryption of a monotonic counter with AES-ECB and without a true-random number generator. In ECB mode, the plaintext may be divided into fixed-size blocks (128 bits for AES). Each block may be encrypted independently using the same key. The same plaintext block may always encrypt to the same ciphertext block when using the same key. In one embodiment, the one-time password 505 may be automatically encrypted and refreshed by AUTOSAR-SHE when it is overwritten with previous encrypted key value. In such an embodiment, the AUTOSAR-SHE module 500 may include a key storage 507 that includes a one-time password 505. The one-time password 505 may be sent to the AES module 509 for encryption. The AES crypto engine 509 may output the encrypted counter value as a signature 521 for storage at the MCU 520.

The system may update the next counter value in an embodiment. For example, AUTOSAR-SHE may update the OTP without using the TRNG if the RAM key in key storage 507 is overwritten with a new value. Instead of calculating a new OTP value, the existing current OTP value may be used as a new value because AUTOSAR-SHE automatically encrypts it. This process works as a pseudo random number generator. The MCU may increase the counter value 523 by an incremental value 525 of one or another number. Once the counter value is increased, the system may feed the updated counter value to the AES-ECB 509 and obtain the signature after encryption. In such an embodiment, there may only be one input required. The system may be tamper resistant and resistant to replay attacks. Furthermore, the implementation may be relatively simple and it may have quick operation compared to other items.

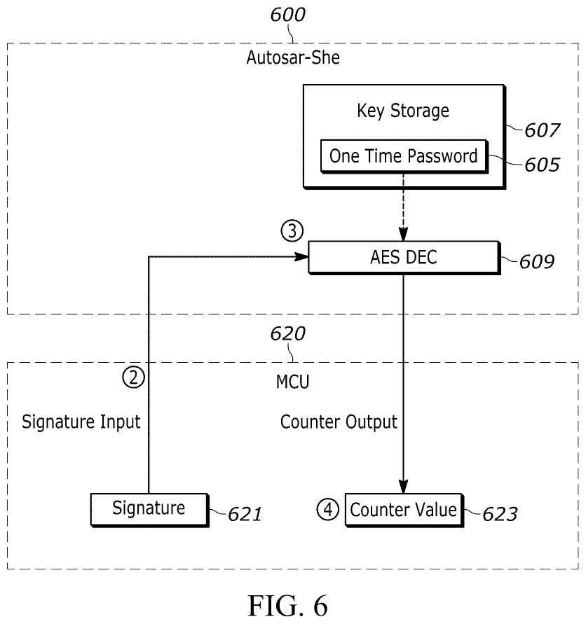

FIG. 6 includes a system overview according to an embodiment including a decryption of a monotonic counter with AES-ECB (electronic codebook mode) without a true-random number generator. During the decryption, the signature may be verified utilizing a verification process according to an embodiment. The AUTOSAR-SHE module 600 may include a key storage 607 with a slot dedicated to a one-time password 605. The system may make sure that the OTP 605 that is stored in the key storage 607 is unchanged. The system may load the signature to the AES crypto engine 609 to begin a decryption process. Once the decryption process is complete by the AES 609, the system may load the signature 621 from the MCU 620 into the AES 609. The system may utilize the result from the decryption process to the AES utilizing the first AES Key. The system may obtain the counter value 623 and compare it with the original value. If the counter value and original value are the predicted numbers (e.g., same numbers), the system may verify the message or data that is being transmitted and allow for communication. If the counter value and original value are not the predicted numbers, the system may be alerted to knowing that there may be a data breach or security issue.

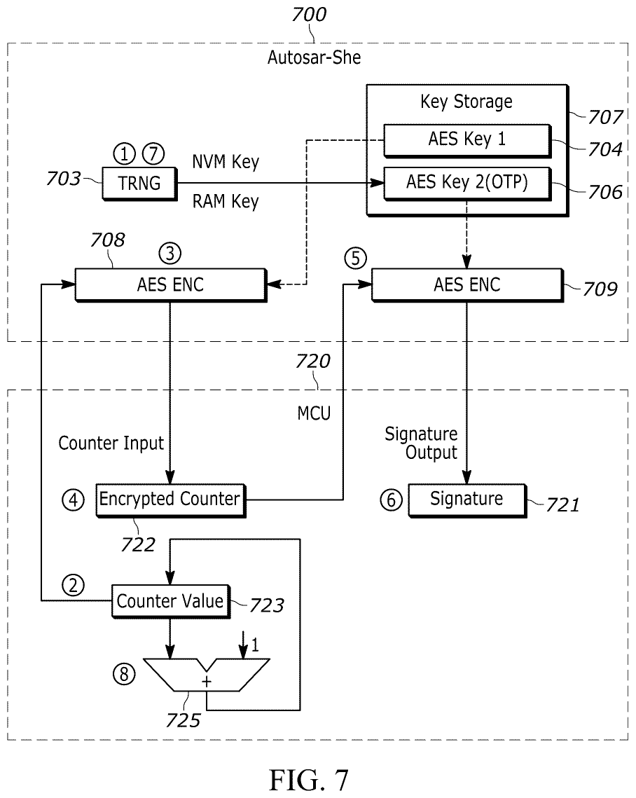

FIG. 7 includes a system overview according to an embodiment including encryption of a monotonic counter with AES-ECB iteration encryption utilizing multiple, dedicated AES keys. The system may include an AUTOSAR-SHE module 700 that includes a true random number generator 703 and a key storage 707. The key storage 707 may include a first AES Key 704 and a second AES KEY 706. The second AES key 706 may be utilized to generate the one-time password (OTP). The second AES Key 706 may be a RAM key. As a first step, the system may generate and store arbitrary value as an immutable symmetric key to AES Key 704. The AUTOSAR module 700 may generate an AES Key 2 utilizing the TRNG 703.

At a second step, the counter value 723 that is located at the MCU 720 may be loaded. The counter value 723 may increase by increments of any value based on an increment counter 725, such as increments of one. At a third step, the AES crypto engine 708 may encrypt the counter value 723 using AES key 704. The AES crypto engine 708 may utilize the AES key 704 for the encryption process to create an encrypted counter 722 at a fourth step.

In a fifth step, the encrypted counter 722 is fed to the same AES crypto engine 709, but with a different AES key utilizing the OTP generated by the second AES key 706. The AES crypto engine 709 may generate the signature 721 utilizing the second AES key 706 and an encryption process. The signature 721 may be utilized for encrypted communication of messages and data.

The system may update the next counter value upon initializing the counter and signature. At a seventh step, the system may generate an updated second AES key 706 utilizing the TRNG 703. The incremental counter 725 may increase the counter value 723. For example, if the counter value 723 was at 5691, the incremental counter 725 may increase the counter value 723 to a new value of 5692. The updated counter value may be loaded and fed in the first AES crypto engine 708 once updated. The counter increment and encryption process is tamper resistant and resistant to replay attacks. Implementation should be fairly easy. However, it may lead to an increase in run-time based on the steps involved.

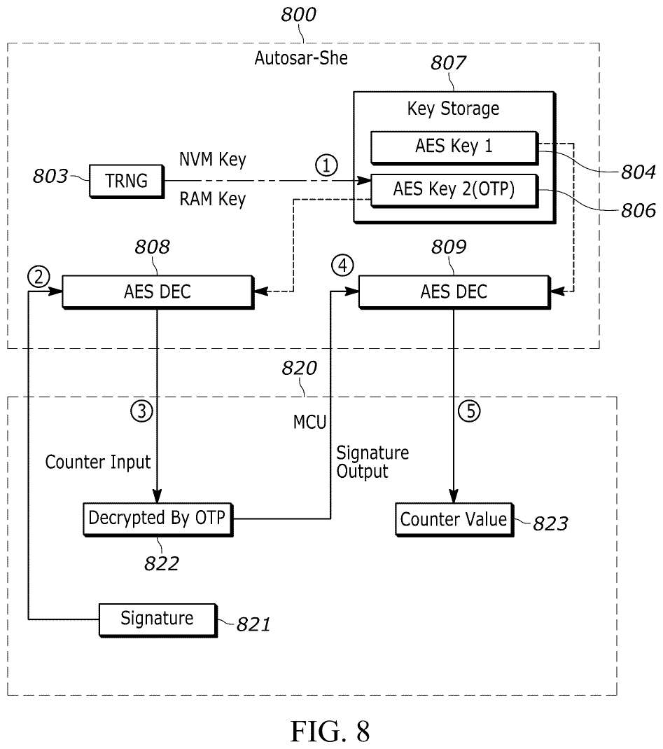

FIG. 8 includes a system overview according to an embodiment including a decryption of a monotonic counter with AES-ECB iteration encryption utilizing multiple, dedicated AES keys. In such an embodiment, the decryption may include a verification process to ensure integrity of the signature. The system may include an AUTOSAR-SHE module 800 that includes a true random number generator 803 and a key storage 807. The key storage 807 may include a first AES Key 804 and a second AES KEY 806. The second AES key 806 may be utilized to generate the one-time password (OTP). The second AES Key 806 may be a RAM key.

At a first step in the verification process, the AUTOSAR-SHE module 800 may ensure that the AES Key 2 806 remains unchanged. The MCU 820 may load the signature 821 into the AES crypto engine 808 for decryption in a second step. In a third step, the system may retrieve a temporary value 822 based on the decrypted signature. The temporary value 822 may be decrypted by the OTP. The temporary value 822 that is decrypted utilizing the OTP may be loaded into the second AES crypto engine 809 for decryption and decrypted utilizing the AES key 1 804 in a fourth step during verification and decryption. In a fifth step, the MCU 820 may retrieve the counter value 823 and compare with the original value. If the counter value and original value are the predicted numbers (e.g., same numbers), the system may verify the message or data that is being transmitted and allow for communication. If the counter value and original value are not the predicted numbers, the system may be alerted to knowing that there may be a data breach or security issue.

Such a decryption and verification process may be tamper resistant as each counter value may have its own unique signature and unique secret key. The signature and key pairs may be unknown. Additionally, it may be replay attack resistant since the OTP changes continuously and is the result of an irreversible and time variant process (e.g., utilizing the counter value).

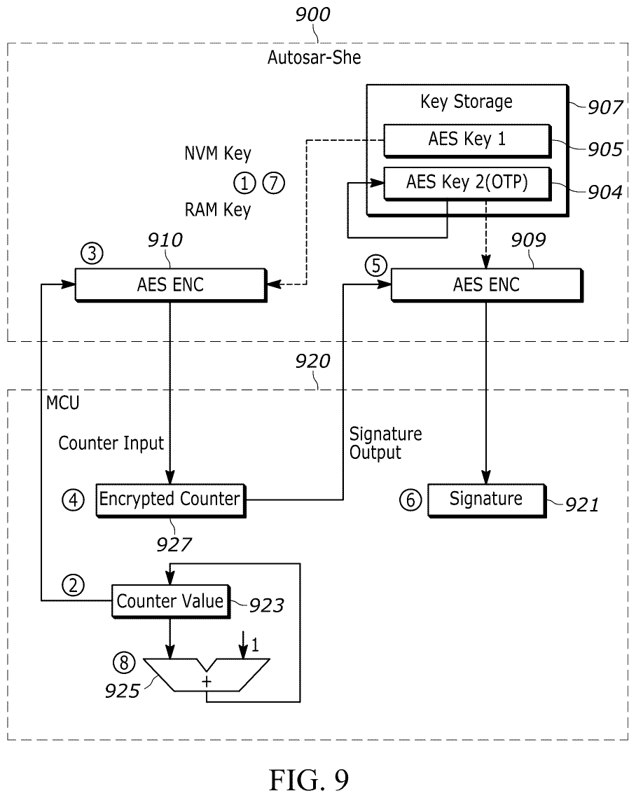

FIG. 9 includes a system overview according to an embodiment including encryption of a monotonic counter with AES-ECB iteration encryption without a true-random number generator. The system may include an AUTOSAR-SHE module 900 that includes a key storage 907. The key storage 907 may be a RAM key with an NVM RAM KEY slot as well. The key storage 907 may include a first AES Key 905 and a second AES KEY 904. The second AES key 904 may be utilized to generate the one-time password (OTP). In such an embodiment without the true random number generator, the one-time password may be a pseudo-random number. Thus, the second AES Key 904 may be a RAM key. As a first step, the AUTOSAR-SHE module 900 may generate a second AES Key (e.g., AES Key 2) that includes a one-time password.

At a second step, the counter value 923 that is located at the MCU 920 may be loaded. The counter value 923 may increase by increments of any value based on an increment counter 925, such as increments of one. As consistent with other embodiments, the counter 925 may be monotonic and may never decrease in count. The first AES crypto engine 910 may be in communication with the AES key storage 907. At a third step, the system may feed the counter value 923 into a first AES crypto engine 910 for encoding. The first AES crypto engine 910 may utilize the first AES key 905 for the encoding process to obtain an encrypted counter 927 at a fourth step.

In a fifth step, the encrypted counter 927 is fed to the second AES crypto engine 909 for encoding utilizing the OTP generated by the second AES key 904. The second AES crypto engine 904 may generate the signature 921 utilizing the second AES key 904 and an encryption process. The signature 921 may be utilized for encrypted communication of messages and data.

The system may update the next counter value upon initializing the counter and signature. At a seventh step, the system may generate an updated second AES key 904 utilizing the RAM KEY slot. The incremental counter 925 may increase the counter value 923. For example, if the counter value 923 was at 5691, the incremental counter 925 may increase the counter value 923 to a new value of 5692. The updated counter value may be loaded and fed in the first AES crypto engine 910 once updated. The counter increment and encryption process is tamper resistant and resistant to replay attacks. However, it may lead to an increase in run-time based on the steps involved.

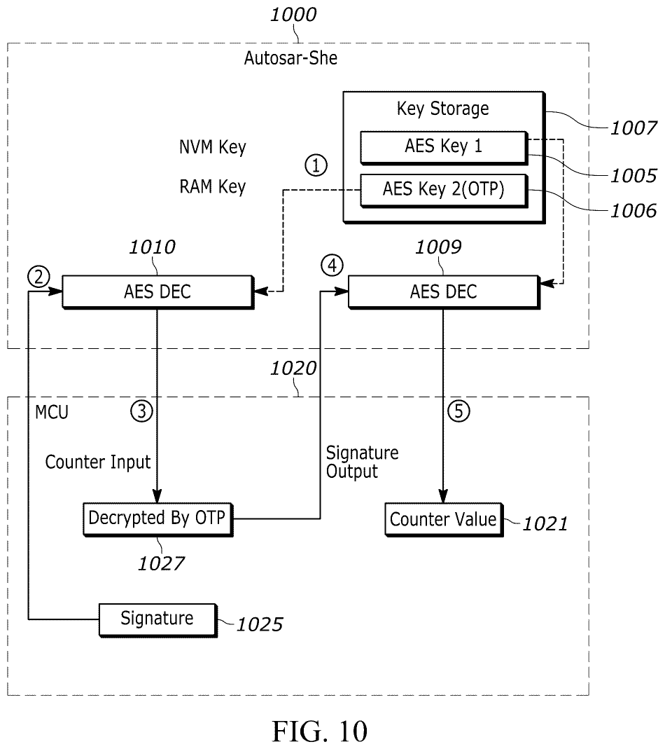

FIG. 10 includes a system overview according to an embodiment including a decryption of a monotonic counter with AES-ECB iteration encryption without a true random number generator. In such an embodiment, the decryption may include a verification process to ensure integrity of the signature. The system may include an AUTOSAR-SHE module 1000 that does not include a true random number generator, or the true random number generator is not utilized. The AUTOSAR module 1000 may include a key storage 1007. The key storage 1007 may include a first AES Key 1005 and a second AES KEY 1006. The second AES key 1006 may be utilized to store and generate a one-time password (OTP). The second AES Key 1006 may be a RAM key.

At a first step in the verification process, the AUTOSAR module 1000 may ensure that the second AES Key 1006 remains unchanged. The MCU 1020 may load the signature 1025 into the AES crypto engine 1010 for decryption in a second step. In a third step, the system may retrieve a temporary value 1027 based on the decrypted signature. The temporary value 1027 may be decrypted by the OTP. The temporary value 1027 that is decrypted utilizing the OTP may be loaded into the second AES crypto engine 1006 for decryption and decrypted utilizing the first AES key (e.g. AES Key 1) 1005 in a fourth step during verification and decryption. In a fifth step, the MCU 1020 may retrieve the counter value 1021 and compare with the original value. If the counter value and original value are the predicted numbers (e.g., same numbers), the system may verify the message or data that is being transmitted and allow for communication. If the counter value and original value are not the predicted numbers, the system may be alerted to knowing that there may be a data breach or security issue.

Such a decryption and verification process may be tamper resistant as each counter value may have its own unique signature and unique secret key. The signature and key pairs may be unknown. Additionally, it may be replay attack resistant since the OTP changes continuously and is the result of an irreversible and time variant process (e.g., utilizing the counter value).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system configured to encrypt vehicle communication, comprising:
a hardware extension including:
a true-random number generator (TRNG) configured to output a true-random number;
a random-access memory configured to store the true-random number as a one-time password and a counter value received from a counter; and
control logic configured to send the one-time password to an advanced encryption standard (AES) block cipher configured to encrypt the one-time password with the counter value to generate a signature; and
a controller in communication with the hardware extension, the controller configured to:
receive, from the AES block cipher, the signature;
store the signature at a memory associated with the controller; and
increase the counter value at the counter to establish a second counter value.

2. The system of claim 1, wherein the AES block cipher is configured to encrypt the second counter value and a second one-time password to create a second signature.

3. The system of claim 1, wherein the TRNG and the random-access memory are components of an Automotive Open System Architecture (AUTOSAR) Secure Hardware Extension compliant unit.

4. The system of claim 1, wherein the signature is encrypted utilizing electronic codebook mode of the AES block cipher.

5. The system of claim 1, wherein the hardware extension is an Automotive Open System Architecture (AUTOSAR) Secure Hardware Extension module.

6. The system of claim 1, wherein the counter is associated with a counter component of the controller and the counter component is not located on the hardware extension.

7. The system of claim 1, wherein the counter is a monotonic counter.

8. A method of verification for cryptographic vehicle communication, comprising:
verifying a one-time password generated from a true-random number generator (TRNG) of a hardware extension, wherein the one-time password is stored at a random access memory (RAM) of the hardware extension;
receiving, from a controller, an encrypted signature at the hardware extension;
decrypting the encrypted signature at an advanced encryption standard (AES) block cipher to obtain a decrypted value;
obtaining a counter value from the controller, wherein the counter value is derived from a monotonic counter; and
comparing the counter value to the decrypted value.

9. The method of claim 8, wherein the TRNG is located at a Secure Hardware Extension (SHE) module and the monotonic counter is located at the controller, wherein the controller is a separate microcontroller unit in communication with the SHE module.

10. The method of claim 8, wherein in response to comparing the counter value to the decrypted value outputs a different value, the method includes a step of outputting a notification indicating a potential security attack.

11. The method of claim 8, wherein in response to comparing the counter value to the decrypted value outputs an equal value, the method includes a step of increasing the counter value at the monotonic counter.

12. The method of claim 8, wherein the RAM is non-volatile random access memory, dynamic random access memory, or static random access memory.

13. The method of claim 8, wherein the one-time password is stored at a RAM key slot of the RAM.

14. The method of claim 8, wherein the monotonic counter is associated with a counter component of the controller and the counter component is not located on the hardware extension.

15. A method of verifying a communication in a vehicle, comprising:
outputting a true-random number utilizing a true-random number generator (TRNG) of a hardware extension;
storing the true-random number in random-access memory (RAM), wherein the RAM is configured to store the true-random number as a one-time password;
receiving, from a monotonic counter, a counter value at the hardware extension;
sending the one-time password to an advanced encryption standard (AES) block cipher configured to encrypt the one-time password utilizing the counter value to generate an encrypted signature;
storing the encrypted signature;
verifying the one-time password generated from the TRNG;
receiving, from a controller, the encrypted signature at the hardware extension;
decrypting the encrypted signature at the AES block cipher to obtain a decrypted value;
obtaining the counter value from the controller, wherein the counter value is derived from the monotonic counter; and
comparing the counter value to the decrypted value.

16. The method of claim 15, wherein the monotonic counter is associated with a microcontroller unit that is a separate component from the hardware extension.

17. The method of claim 15, wherein the hardware extension is an Automotive Open System Architecture (AUTOSAR) Secure Hardware Extension located in the vehicle.

18. The method of claim 15, wherein in response to comparing the counter value to the decrypted value outputs an equal value, the method includes a step of increasing the counter value at the monotonic counter.

19. The method of claim 15, wherein the counter value is an only input to the hardware extension from a separate component.

20. The method of claim 15, wherein the one-time password is stored at a dedicated RAM key slot of the RAM.
